(19) United States
(12) Patent Application Publication
(10) Pub. No.: US 2008/0102248 A1
(43) Pub. Date: May 1, 2008

(54) GRIP BELT HAVING LARGE-SIZED AIR CELLS

(76) Inventor: Chun-Fu Chang, (US)

Correspondence Address: FANNY CHUNG, ROOM 1, 7F, NO. 186, SEC. 2, DONG-SHING RD., TAICHUNG CITY (R.O.C.), 408, omitted

(21) Appl. No.: 11/555,268

(22) Filed: Oct. 31, 2006

(51) Int. Cl. B32B 3/10

(52) U.S. Cl. 428/137; 428/160

(57) ABSTRACT

A grip belt for serving a grip of which skidproof and shock-absorbing properties are required possesses large-sized air cells internally and dents on the surface thereof formed during manufacture to perform enhanced shock-absorbency, tender touch, firm feel and skidproof efficiency.

### BACKGROUND OF THE INVENTION

1. Technical Field

The present invention is related to a grip belt for serving a grip or handle of which skidproof and shock-absorptive properties are required, and more particularly to a polyurethane-coated grip belt that possesses large-sized air cells formed during manufacture that facilitate performing enhanced shock-absorbency, tender touch, firm feel and skidproof efficiency.

2. Description of Related Art

An existing polyurethane-coated grip belts, such as the one disclosed in U.S. Pat. No. 5,851,632 of which one of the inventor is the identical inventor and applicant of the present invention, primarily comprises a base layer and an elastic polyurethane-based coating layer are known to be prepared with wet production of polyurethane resin synthetic leather.

During said wet production of polyurethane resin synthetic leather, the process typically involves applying a mixture of polyurethane (hereinafter referred to as “PU”) and dimethylformamide (hereinafter referred to as “DMF”) on a wet nonwoven sheet, bathing the mixture-applied nonwoven sheet in water to make DMF partially dissolved and removed from the PU-DMF mixture to cause air cells in the mixture, drying the resultant nonwoven sheet and cutting and drilling the semi product as need to realize a belt grip.

However, such existing PU-coated grip belts may have following problems that inspire the inventor of the present to improve:

1. The dissolving efficiency of DMF can be significantly limited by the obstruction of the integral nonwoven sheet and therefore only small-sized air cells can be formed in the elastic layer. As a result, the shock-absorbency of the grip belt may be depressed.

2. Since the PU coating is merely attached to the surface of the nonwoven sheet as a thin layer, the thickness thereof may not sufficient to provide competent shock-absorbency.

3. As such grip belts usually require a late process of holes drilling after the elastic PU-based layer has been hardened to provide skidproff function, holes running through the PU layer and base layer may increase the risk of tearing while the resultant grip belt is stretched for binding on an objective grip or while a grip user holds and rubs the bound grip.

### SUMMARY OF THE INVENTION

The present invention has been accomplished under the circumstances in view.

It is one object of the present invention to provide a grip belt, which is manufactured by applying a PU-DMF mixture on a pre-drilled base layer so that the dissolving efficiency of DMF can be significantly enhanced to form large air cells that provide excellent shock-absorbency.

It is another object of the present invention to provide a grip belt, which has the PU-based coating layer partially extending into the base layer to possess an increased thickness that facilitates providing enhanced shock-absorbency, firm feel and tender touch.

It is still another object of the present invention to provide a grip belt, which provides skidproof function by a plurality of dents formed naturally when the fluid PU-DMF mixture passes over the pre-drilled base layer. Thus, the drilled holes on semi product of the prior art can be dispensed and the presently disclosed grip belt can be more durable over frequent use.

### BRIEF DESCRIPTION OF THE DRAWINGS

FIG. 1 is a top view of a grip belt according to the present invention;

FIG. 2 is a bottom view of a grip belt according to the present invention;

FIG. 3 is a sectional view taken in an enlarged scale along Line 3-3 of FIG. 1;

FIG. 4 is an enlarged view of area A in FIG. 3;

FIG. 5 is an applied view showing the disclosed grip belt applied to a grip;

FIG. 6 is a sectional view taken in an enlarged scale along Line 6-6 of FIG. 5; and

FIG. 7 is an applied view showing a grip bound with the disclosed grip belt pressed by a human finger.

### DETAILED DESCRIPTION OF THE PREFERRED EMBODIMENT

Dissimilar to prior art, the disclosed subject matter of the present invention has improved structure while involving the same technology of wet production of polyurethane resin synthetic leather.

Said structure of disclosed subject matter primarily comprises a base layer with a plurality of through holes, which can be made of any kind of absorbent fabric and having a plurality of through holes thereon, and a PU-based elastic layer attached to the base layer that is extending into and filling up said through holes which includes external dents with the amount corresponding to said through holes and innumerable internal air cells wherein some air cells large are presented within said through holes, some air cells middle are presented adjacent to said through hole, and some air cells small are presented adjacent to the surface of the PU-based elastic layer, wherein the middle air cell is approximately 3 times larger than the small cells and the large air cell is approximately 20 to 30 times larger than the small cells.

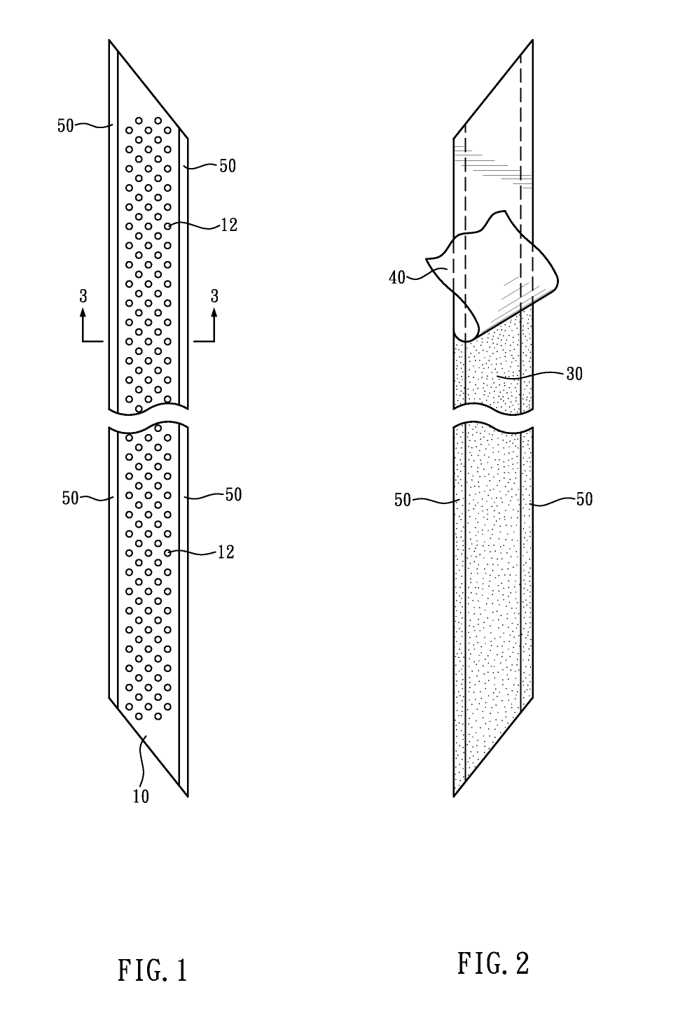

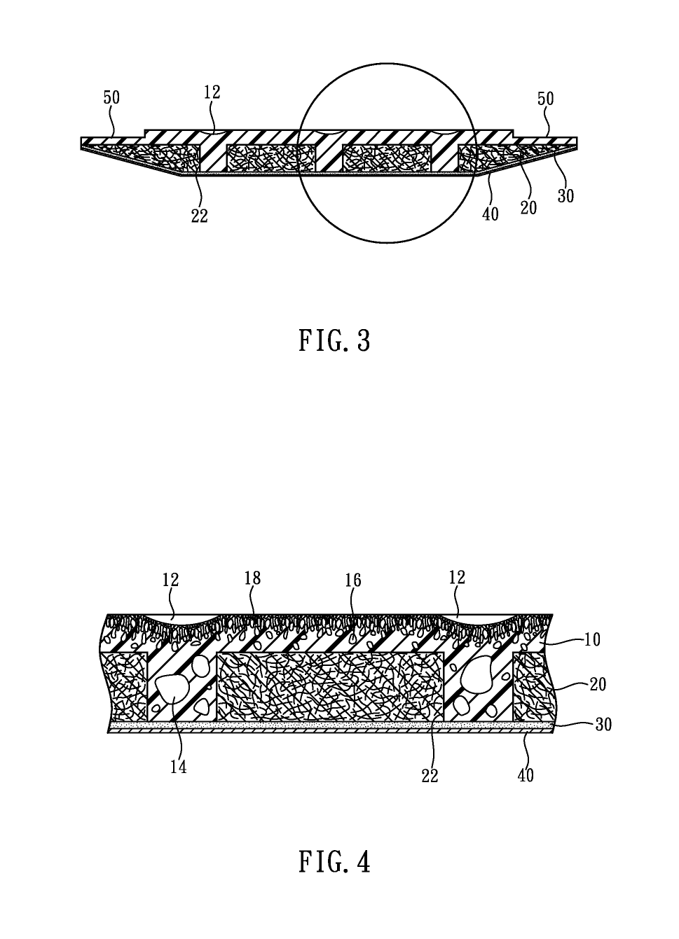

As can be seen in FIGS. 1 to 3, which illustrate one embodiment of the present invention, a grip belt product structully comprises a PU-based elastic layer 10, a base layer 20, an adhesive layer 30 and a protective layer 40. According to the particular embodiment, the base layer 20 can be a nonwoven sheet which is previously drilled with a plurality of through holes 22 extending from the top surface to the bottom surface which are spaced from each other by a predetermined interval. To form and attach the PU-based elastic layer 10 onto the base layer 20, base layer 20 is firstly wetted, and a PU-DMF mixture which contains pigment, surface active agent, PU and DMF is applied evenly thereupon. As the PU-DMF mixture is now in a fluid form, it can fill up the through holes 22 of the base layer 20 and a plurality of dents 12 can be uniformly formed at the surface of the PU-DMF mixture answering to sinking happened when the mixture encounters the through holes 22. Then the combination of the base layer 20 and the PU-DMF mixture is immersed in water to make DMF dissolved and removed, and said innumerable air cells are therefore formed. It is to be noted that during the dissolving of DMF, since DMF dissolution of PU-DMF mixture in and around the through holes 22 can be almost completely achieved for free from the obstruction of the base layer 20. Therefore, air-cells that are much more larger than those of the prior art PU-based elastic layer can be formed at the location corresponding to the through holes 22. The immersed combination is successively dried with hot air to become a semi-product having a base layer 20 and PU-based elastic layer 10.

According to this embodiment, said semi-product is further cut in desired shape and has the edge portions 50 recessed for reinforcement and facilitating binding.

FIG. 4 presents an enlarged view of the resultant grip belt. The distribution of the large air cells 14, middle air cells 16 and small air cells 18 can be understood fully through the drawing. As described above, the small air cells 18 similar to those of the prior art PU-based elastic layer are formed densely about the surface of the upper surface of the PU-based elastic layer 10, and since the through holes 22 provide unobstructed routes for water to dissolve and remove DMF, air cells produced within and adjacent to the route can be much more larger than those produced out of the route. In terms of one embodiment of the present invention, the middle air cell is approximately 3 times larger than the small cells and the large air cell is approximately 20 to 30 times larger than the small cells.

It is known that as to a shock-absorbent or cushion material, more and larger internal air cells it possesses, the better shock-absorbency it presents. Thus, the disclosed subject matter can provide improved shock-absorbency with the especial large and middle air cells it has.

Also can be seen clearly in FIG. 4 is the dents 12 that are formed at the upper surface of the PU-based elastic layer 10. As described before, the dents 12 are formed naturally when fluid PU-DMF mixture is pored on the base layer 20 and encounters the through holes 22. Such dents 12 cause irregularity of the PU-based elastic layer 10 that efficiently provide essential friction to a gripping hand.

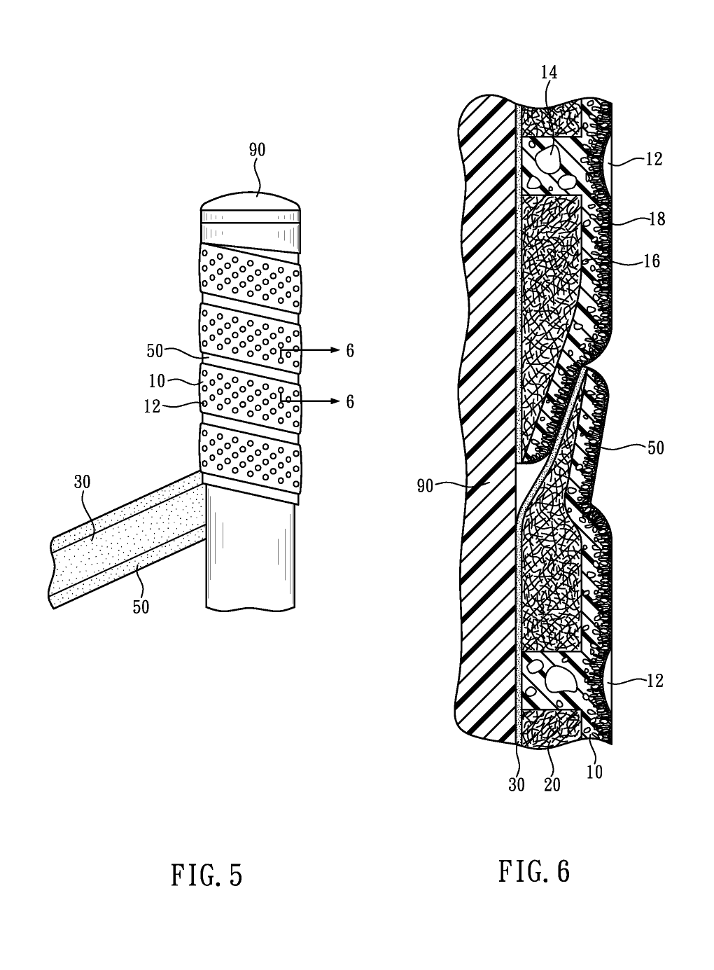

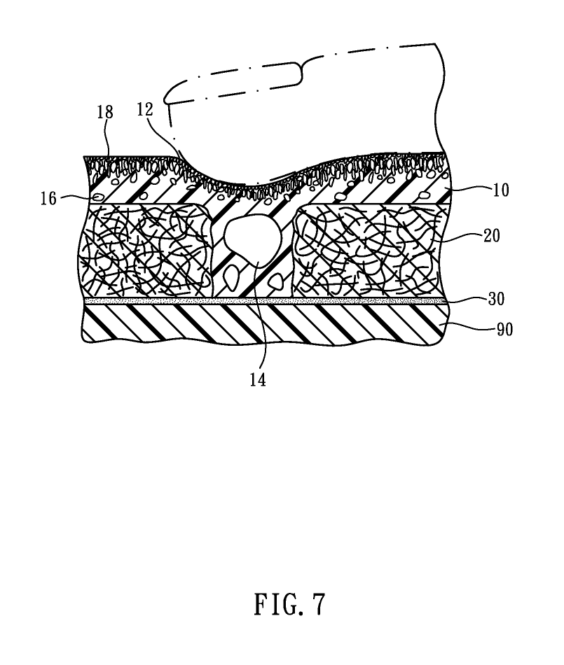

When the disclosed grip belt is wound on a grip 90 of an article, as shown in FIGS. 5, 6, and 7, since the PU-based elastic layer 10 formed interlaced to the base layer 20, the thickness thereof is partially extended and provides a firm feet and tender touch to a user's gripping hand. Meantime, the large air cells 14, middle air cells 16 and small air cells 18 which are formed internally at the PU-based elastic layer 10 perform competent shock-absorbency while the dents 12 give the gripping hand sufficient friction for skidproof function.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

What is claimed is:

1. A grip belt primarily comprising a base layer having a plurality of through holes thereon, and a PU-based elastic layer attached to the base layer that is extending into said through holes which includes external dents with the amount and locations corresponding to said through holes and a plurality of internal air cells wherein some air cells large are presented within said through holes; some air cells middle are presented adjacent to said through hole; and some air cells small are presented adjacent to the surface of the PU-based elastic layer.

2. The grip belt as claimed in claim 1, wherein the base layer is made of an absorbent fabric.

3. The grip belt as claimed in claim 2, wherein the base layer is made of nonwoven.

4. The grip belt as claimed in claim 1, wherein the PU-based elastic layer is formed by the method of wet production of polyurethane resin synthetic leather.

5. The grip belt as claimed in claim 1, wherein the middle air cell is approximately 3 times larger than the small cells.

6. The grip belt as claimed in claim 1, wherein the large air cell is approximately 20 to 30 times larger than the small cells.
